(19) United States
(12) Patent Application Publication
(10) Pub. No.: US 2014/0007019 A1
(43) Pub. Date: Jan. 2, 2014

(54) METHOD AND APPARATUS FOR RELATED USER INPUTS

(71) Applicants: Jari Olavi Saukko, Tampere (FI); Mikko Antero Nurmi, Tampere (FI)

(72) Inventors: Jari Olavi Saukko, Tampere (FI); Mikko Antero Nurmi, Tampere (FI)

(73) Assignee: NOKIA CORPORATION, Espoo (FI)

(21) Appl. No.: 13/538,556

(22) Filed: Jun. 29, 2012

(51) Int. Cl. G06F 3/0484

(52) U.S. Cl. CPC G06F 3/0484
USPC 715/863

(57) ABSTRACT

In accordance with an example embodiment of the present invention, a method, comprising detecting a first user input, detecting a second user input, outside a graphical user interface area, at a location of a component, determining whether the first user input and the second user input relate to each other, and in response to a positive determination that the first user input and the second user input relate to each other, enabling a user to interact with the component.

### TECHNICAL FIELD

The present application relates generally to user inputs and how to control functionality of a device. Certain disclosed aspects or embodiments relate to portable electronic devices which may be hand-held in use.

### BACKGROUND

Electronic devices, such as home computers, mobile telephones and tablet computers, may be used for many purposes via different user applications. For example, a user of a mobile telephone may use an in-built camera of the mobile telephone to take photos or movies using a camera application. The user may send and receive different types of message (such as SMS, MMS and e-mail) using the mobile telephone and messaging applications. The user may also use the mobile telephone to play games via gaming applications, and view and update social networking profiles using one or more social networking applications. Many other tasks may be performed using the mobile telephone and appropriate user applications and the user may be enabled to influence the way the user applications perform the tasks.

When the user creates content, such as by taking a new photo or composing a new e-mail, the time and date when the content was created may be stored. Storing the time and date may be optional and the user may determine, using input means, if the date and time is to be stored, and if so, in which format. For example, the user may determine that if the user takes a photo with a digital camera, the photo may be stored alongside the time and date when the photo was taken. As another example, if a user replies to an e-mail then the time and date when the reply was transmitted may be included with the reply, so that, for example, the sender and recipient of the e-mail have a record of when the message was transmitted. The user may determine this and use input means to select this to happen.

### SUMMARY

Various aspects of examples of the invention are set out in the claims.
According to a first example of the present invention, there is provided a method, comprising:
   detecting a first user input;
   detecting a second user input, outside a graphical user interface area, at a location of a component;
   determining whether the first user input and the second user input relate to each other; and
   in response to a positive determination that the first user input and the second user input relate to each other, enabling a user to interact with the component.
According to a second example of the present invention, there is provided an apparatus, comprising at least one processor and at least one memory including computer program code, the at least one memory and the computer program code configured to, with the at least one processor, cause the apparatus at least to:
   detect a first user input;
   detect a second user input, outside a graphical user interface area, at a location of a component of the apparatus;
   determine whether the first user input and the second user input relate to each other; and
   in response to a positive determination that the first user input and the second user input relate to each other, enable a user to interact with the component.
According to a third example of the present invention there is a computer program product comprising a computer-readable medium bearing computer program code embodied therein for use with a computer, the computer program code comprising:
code for detecting a first user input;
code for detecting a second user input, outside a graphical user interface area, at a location of a component;
code for determining whether the first user input and the second user input relate to each other; and
code for, in response to a positive determination that the first user input and the second user input relate to each other, enabling a user to interact with the component.
According to a fourth example of the present invention, there is an apparatus, comprising
means for detecting a first user input;
means for detecting a second user input, outside a graphical user interface area, at a location of a component of the apparatus;
means for determining whether the first user input and the second user input relate to each other; and
means for enabling, in response to a positive determination that the first user input and the second user input relate to each other, a user to interact with the component.
The terms “a first user input” and “a second user input” do not necessarily imply an order of user inputs, but are used to indicate existence of two distinct user inputs. The term “user input” refers to methods used by a user to provide input. Examples of user input include: touch input, in which the user uses an object, such as a finger or a stylus, to touch a user interface of an apparatus/device; pressing of a button; hover input, for example in which hovering of a user's palm or finger is detected; and voice commands.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example embodiment comprising a number of electronic components, including memory and a processor;

FIG. 2 depicts an example embodiment comprising a number of electronic components, including memory, a processor and a communication unit;

FIGS. 3a to 3d form an illustration of an example embodiment involving a camera component;

FIGS. 4a an 4b form an illustration of an example embodiment involving an antenna;

FIGS. 5a to 5c form an illustration of an example embodiment involving a memory card slot;

FIGS. 6a to 6c form an illustration of an example embodiment involving a headset;

FIGS. 7a to 7d form an illustration of an example embodiment involving at least one SIM card slot and

FIG. 8 is a flowchart illustrating an embodiment of the invention.

### DESCRIPTION OF EXAMPLE ASPECTS/EMBODIMENTS

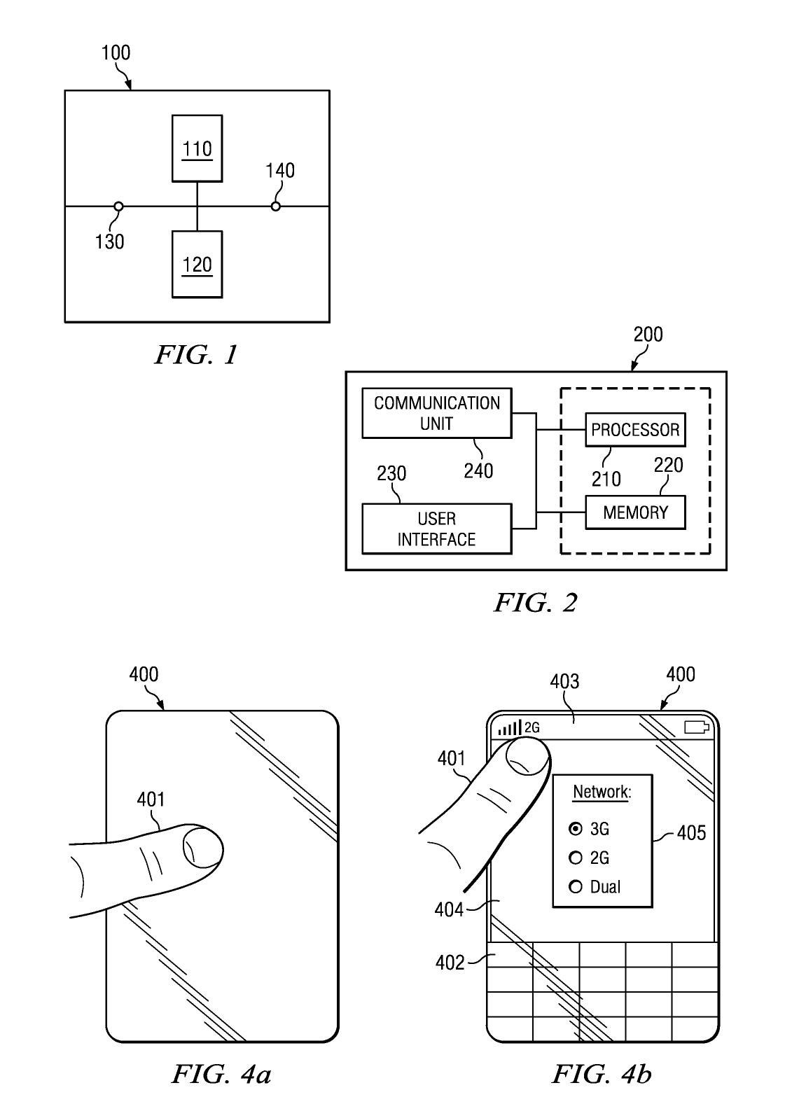

Example aspects/embodiment of the present invention and its potential advantages are understood by referring to FIGS. 1 through 8 of the drawings.

FIG. 1 depicts an apparatus 100 that comprises a processor 110, a memory 120, an input 130 and an output 140. The apparatus 100 may be an application specific integrated circuit, ASIC, for a device. The apparatus may be the device itself or it may be a module for a device. Although this embodiment shows only one processor and one memory, it should be noted that other embodiments may comprise a plurality of processors and/or a plurality of memories. The processors could be of the same type or different types. The memories could as well be of the same type or different types.

The input 130 enables the apparatus 100 to receive signaling from further components while the output 140 enables onward provision of signaling from the apparatus 100 to further components. The processor 110 may be a general purpose processor dedicated to execution and/or processing information. Information may be received via the input 130. The execution or processing of information is done in accordance with instructions stored as a computer program code in the memory 120. The operations performed by the processor 110 produce the signaling that may be provided onward to further components via the output 140. The memory 120 is a computer-readable medium that stores computer program code. The memory may comprise one more memory units. The computer-readable medium may be for example, but not limited to, a solid state memory, a hard drive, ROM, RAM or Flash. The computer program code comprises instructions that are executable by the processor 110, when the program code is run on the processor 110. The memory 120 and the processor 110 are connected such that an active coupling between the processor 110 and memory 120 allows the processor to access the computer program code stored on the memory 120. The processor 110, memory 120, input 130 and output 140 may be electrically connected internally to allow the components to communicate with each other. The components may be integrated to a single chip or circuit for installation in an electronic device. In other embodiments one or more or all of the components may be located separately, for example, throughout a portable electronic device, such as device 200 shown in FIG. 2, or through a “cloud”, and/or may provide/support other functionality.

One or more examples of apparatus 100 may be used as a component for a device as in FIG. 2 that shows a variation of apparatus 100 incorporating the functionality of apparatus 100 over separate components. In other example embodiments, the device 200 depicted in FIG. 2 may comprise apparatus 100 as a module, as is illustrated in FIG. 2 by the dashed line box, for a device such as a mobile phone, a smart device, PDA, tablet computer or the like. Such a module, apparatus or device may just comprise a suitably configured memory and processor. The device 200 is such that it may receive data and it may also provide data. It also allows a user to interact with it and control the functionality of the device 200.

The example device 200 depicted in FIG. 2 comprises a processor 210, a memory 220, a user interface 230 and a communication unit 240. The processor 210 may receive data from the memory 220, the user interface 230 or the communication unit 240. Data may be output to a user of device 200 via the user interface 230, and/or via output devices provided with, or attachable to the device 200.

The memory 220 may comprise computer program code in the same way as the memory 120 of the apparatus 100. In addition, the memory 220 may also comprise other data. The memory 220 may be an internal built-in component of the device 200 or it may be an external, removable memory such as a USB memory stick, a memory card or CD/DVD ROM for example. The memory 220 is connected to the processor 210 and the processor may store data for later use to the memory 220.

The user interface 230 may include one or more components for receiving user input, for example, a keypad, a touch display, a microphone and a physical button. The user interface 230 may also comprise a proximity sensing feature that enables the device to detect hover gestures made by a user using his thumb, finger, palm, or other object, over a proximity-sensitive region of the device 200. The proximity-sensitive region may be located at a certain part of the device 200 or it may extend such that hover gestures may be detected proximate to any part of the device 200. The proximity sensing feature may be provided by capacitive sensing technology, for example, or by any other suitable method. The user interface may also include one or more components for providing output to the user. Such components may include for example a display, which may be for example a touch display, an LCD display, an eInk display or a 3D display, components for providing haptic feedback, a headset and loud speakers. It should be noted that the components for receiving user input and the components for providing output to the user may be components integrated to the device 200 or they may be components that are removable from the device 200.

The communication unit 240 may comprise for example a receiver, a transmitter and/or a transceiver. The communication unit 240 may be in contact with an antenna and thus enable connecting to a wireless network and/or a port for accepting a connection to a network such that data may be received or sent via one or more types of networks. The types of network may include for example a cellular network, a Wireless Local Area Network, Bluetooth or the like. The communication unit 240 may also comprise a module enabling the device 200 to connect to a wired network such as a Local Area Network, LAN, for example.

A device offering a user a possibility to interact with and control functionality of its components enables the user to choose suitable settings for the functionality of the components. A component of the device may be a physical part of the device that performs certain functionality. The component may be removable or it may be integrated into the device. Examples of such components are a camera, a removable memory unit, a keyboard, a display, a headset or an antenna. As a component of the device performs certain functionality, there may be one or more settings that characterize that functionality. A setting may be a predefined value that has been selected to characterize one or more aspects of the functionality of the component. The selection of a predefined value may be done automatically or by the user. Settings may characterize, for example, how the layout of a virtual keyboard looks, how loudly the device plays audio files, what the quality of the pictures taken with the camera of the device is, etc. In other words, the settings offer a user a way to control the functionality of one or more components of the device. Using existing technologies, in order to adjust the settings the user usually first has to navigate on the user interface of the device to reach a view in which the user is enabled to view and change current settings. In order to change a setting, the user may typically select one of a set of predefined values for the setting.

When the user decides to influence the functionality of at least one component of the device, the user might not know how to access the particular setting, or settings, characterizing the functionality. For example, if a user wishes to change settings that characterize the functionality of a camera, the camera being a component included in the device, the user might not know if he should open a certain application (such as the camera application, which is an application associated with the camera component) available on the device or if there is an application for settings in general, such as a general settings application, available on the device from which the user could access the settings characterizing the functionality of the camera. In an example of an existing device, it might be that the settings of the camera are to be accessed via the general settings application, but settings relating to functionality of a SIM card included in the device are not, for example, which could cause confusion to the user: if the device contains several components and the functionality of those components can be controlled by adjusting settings, it would be tedious for the user to memorize how to access settings relating to the functionality of each component. It might also be that the user does not know how to access the general settings application. There might be an icon for the general settings application visible in some view of the device. Yet, if the settings relating to functionality of the camera are found from an application associated with the camera instead of the general settings application, it might not be obvious to the user that the settings relating to the functionality of the camera are accessed from the application associated with the camera. Further, it could be that the application associated with the camera contains a menu dialog in which the settings relating to functionality of the camera are listed as selectable objects from which the user may then select suitable ones.

In another example, the viewfinder of the camera may contain an icon representing the settings relating to the functionality of the camera and these settings can be accessed by selecting the icon. As there can be various ways to interact with a component included in a device, from the user's point of view, it would be desirable to be able to interact with each component in a consistent, intuitive way.

One way to offer the user a more intuitive way to interact with the device, such that the user is enabled to easily access settings relating to functionalities of components, is to have a new approach toward accessing the settings. In example embodiments the invention provides such new approaches. In one example embodiment of the invention, if there is an icon for the settings application visible in an application view of the device, then the combination of the icon becoming selected and detecting an input at a location of a component would enable a user to interact with the component and thus access the settings relating to functionality of the component. Accessing the settings may provide the user a possibility to view the settings relating to the functionality of the component and, if the user desires, change them. That is, the user may be enabled to interact with the component. In one example, the user provides a user input by touching the settings icon displayed on a touch display of the device, which causes the icon to become selected. After this the user provides another user input by hovering over the lens of the camera of the device and holding the finger still for a while near the camera. As a result, the settings view for the camera is displayed and the user is enabled to interact with the camera, which is a component included in the device, and thus view and/or change the settings relating to the functionality of the camera. In another example, the user provides a user input by touching the lens of the camera first. After that the settings icon may be displayed on the touch display of the device and may be tapped by the user, the tapping being now another user input provided by the user causing the settings icon to become selected. This causes the settings menu to be displayed to the user on the touch display such that the user is now enabled to interact with the camera, in this example by accessing the settings relating to the functionality of the camera.

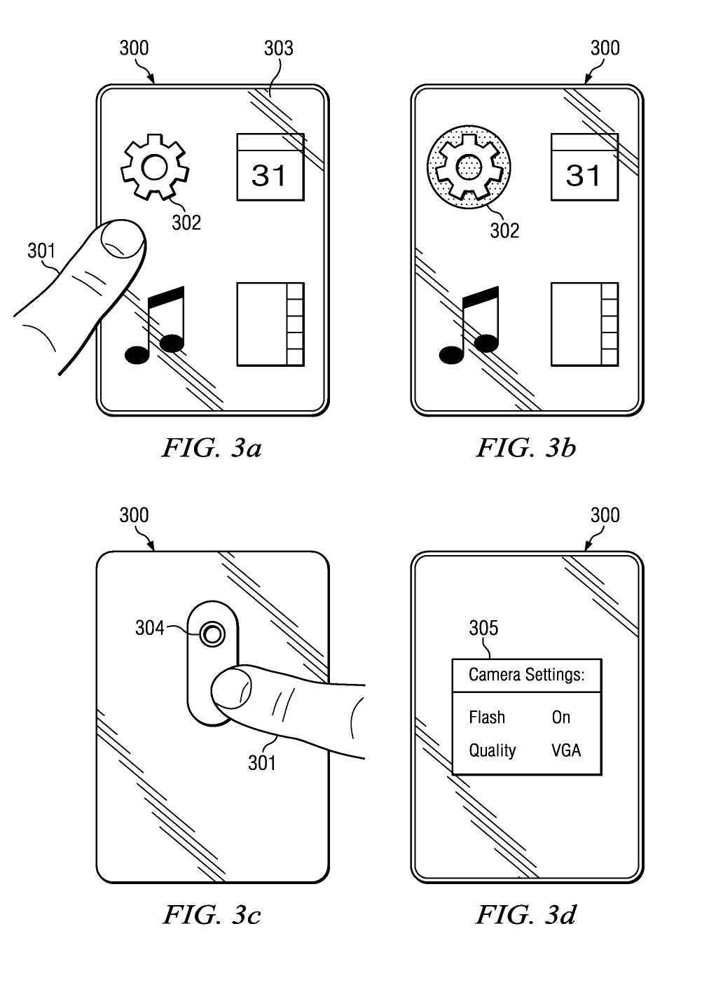

FIGS. 3a-3d depict an example embodiment in which the user wants to interact with a component included in a smart phone 300 and located outside a graphical user interface area by accessing the settings relating to the functionality of the component. The graphical user interface area of the smart phone 300 comprises a display that is configured to display a graphical user interface 303. In general, the graphical user interface area may enable a user to interact with images, text or other data visible on a display of a device. If there is an input detected outside the graphical user interface area, then the input is detected at a location of a component that is not part of the graphical user interface area. Such a location may be, for example, a location of a camera component, a location of an antenna component or any other location of a component that has no direct association to the interaction that happens using images in addition, or alternatively, to text as means for the interaction. In this example embodiment, the display on the smart phone 300 is capable of detecting touch input received on the display thus allowing the user to interact with the smart phone 300 by using touch inputs as user input. In addition to detecting touch inputs, the smart phone 300 in this example embodiment is also able to detect hovering of a finger 301 in close proximity to the smart phone 300 and determine at least an approximate location of the finger. In this example embodiment, the hovering can be detected not just above the display but, for example, proximate to the back of the phone as well. It should be noted that in this example embodiment, if a user input is detected outside the graphical user interface area, the user input is detected outside the area of the display of the smart phone 300. In FIG. 3a, the smart phone 300 displays its home screen. In this example embodiment, the home screen contains icons that represent applications of the smart phone 300. In the example embodiment, if the user touches an icon using his finger 301, the icon becomes selected. If the user double-taps the icon, or alternatively touches a selected icon again, the application the icon represents is opened.

In this example embodiment, the user wishes to access the settings of the camera incorporated in the smart phone 300, so the user first touches the icon 302 that represents a settings application. Touching the icon 302, representing the settings application, causes the icon 302 to become selected as is illustrated in FIG. 3b. In this example embodiment, if the user now tapped another icon on the home screen of the smart phone 300, that would cause the other icon to become selected making the icon 302 unselected again. Further, if the user now touched the icon 302 again, the setting application would be opened. Should the user double-tap another icon while the icon 302 is selected, the icon 302 would cease to be selected and the application that is represented by the icon the user double-tapped, would be opened.

However, if the icon 302 is selected, which has triggered the smart phone 300 to enter a detection state, in which it detects if the subsequent user input is to be determined to relate to the user input that caused the icon 302 to become selected, and the user hovers on top of the camera lens 304 using his finger 301 as illustrated in FIG. 3c, the smart phone 300 in this example embodiment detects that there was a user input that caused the icon 302 to become selected and that there is another user input at the location of the camera that relates to the previously detected user input. In general, the detection state is a state in which it is checked if two user inputs detected sequentially are such that they may be interpreted to relate to each other. To enter the detection state, a specific user input may be used, such as a double tap on a display for example. In an example of a specific user input (e.g., double tap) being used to trigger a detection state, two subsequent user inputs, after the specific user input, may then be analysed to determine whether they relate to each other. For example, a user may wish to inform the device that he intends to make two related inputs (e.g. in order to control a device component), so he may perform a double tap to enter the detection state, and then perform two further inputs (e.g., tapping a physical component such as a camera and then touching a settings icon) to initiate an operation for controlling the component. Alternatively, the detection state may be entered automatically when certain conditions exist, such as when an icon has become selected as is the case in the example embodiment of FIGS. 3a-3d. For example, after a certain user input, such as a hover user input outside the graphical user interface area or a double tap on a display, has been detected, the detection state is automatically entered and the hover or double tap user input is considered by the device to be a first input, and a second, related input is then awaited by the device. The detection state may be exited once related user inputs are detected or alternatively after a pre-determined time period has lapsed. In the example embodiment of FIGS. 3a-3d, the hover input is determined to be an intended user input, if the user holds his finger 301 still on top of the camera lens 304 for at least a certain period of time which could be, for example, half a second. In order to be able to associate the detected hover input on top of the camera lens 304 with the previous input, the smart phone 300 has, in this example embodiment, a database from which it may be checked if two user inputs are related to each other. As the smart phone 300 is also aware of the location of the camera lens 304, it may determine if the user input making the icon 302 selected and a user input at the location of the camera lens 304 are related by checking from the database if the combination of the two user inputs is to be interpreted such that they relate to each other.

In this example embodiment, causing the settings icon 302 to become selected causes the smart phone 300 to enter the detection state in which it can detect a subsequent user input and determine if such subsequent user input is related to the detected user input that caused the settings icon 302 to become selected. If no user input is received during a pre-determined time after entering the detection state, the smart phone 300 may exit the detection state. In this example embodiment, as the smart phone 300 is in the detection state and the subsequent user input is detected at the location of the camera lens 304 within the pre-determined time, it may be checked from a database if the combination of the user inputs is such that an interpretation of the user inputs being related to each other can be made. That is, the database may contain information that defines the user inputs that may be interpreted to relate to each other. For example, once the user input causing the icon 302 to become selected has been detected, a query may be sent to the database to see which user inputs, in combination with the detected user input, may be interpreted to relate to each other. Alternatively, other methods may be used to determine if two user inputs may be interpreted to relate to each other. For example, computer code executed in the smart phone 300 may include an algorithm that checks if two user inputs are related to each other and thus a database is not needed. Whether two user inputs may be interpreted to relate to each other or not may depend on the context in which the user inputs are detected. For example, the application that is active at the time the first user input is detected, the type of the detected user input or the location in which the user input is detected.

Once it has been detected that the two detected user inputs relate to each other, the smart phone 300 in this example embodiment enables the user to interact with the camera by providing a settings view 305 relating to the functionality of the camera on the display. This settings view 305 includes all the selectable options that relate to the functionality of the camera. Each option may have different pre-defined values that can be selected. Each pre-determined value may cause the camera to function in a different way. Yet it should be noted that the options shown in settings view 305 do not comprise an exhaustive list of options that may exist. One selectable value, for example, relates to aspects of the functionality of a flash light of the camera. For example, if the setting for the flash is “on”, the camera will capture an image using flash light. If the flash light is “off”, the camera will not use the flash light when capturing an image even if the detected ambient light conditions would suggest that flash light would be useful. If the flash light setting is set to be “automatic”, then the camera itself detects the conditions regarding ambient light and determines if the flash light is to be used or not. By enabling the user to interact with the settings relating to the functionality of the camera, the camera is caused to function in a way that meets the user's wishes. The user can change the settings relating to the functionality of the camera by using the input means of the smart phone 300. For example, the user may use the touch display and tap the setting that the user wishes to change. If all of the settings are not visible on the screen at the same time, then the user may scroll through the screen by using a flicking gesture, for example. The user could also interact with a voice user interface of the smart phone 300 and control the settings relating to the functionality of the camera by dictating commands. The smart phone 300 could then use its speech recognition capabilities to control the settings view and select the correct pre-determined value.

It should be noted that even though the user is enabled to interact with the camera component by making the settings icon selected and then providing an input at the location of the camera component, it is not implicated that there are no alternative ways to access the settings of the camera component of the smart phone 300. For example, the settings application could include the settings relating to the functionality of the camera and those could be accessed by navigating in the settings application, for example in a conventional manner. On the other hand, it could also be that the settings application does not include the settings for the camera component of the smart phone 300, but accessing an application relating to the camera may provide the user the possibility to interact with the camera component and access and edit the settings relating to the functionality of the camera component. Each of these means for interacting with the camera component may be present at the same time as alternatives to each other.

A further alternative to the example embodiment described above is that once the user has tapped the settings icon 302, the settings application is opened instead of the settings icon 302 becoming selected. Yet, if the user, within the pre-determined time after the settings application has been opened, hovers at the location of the camera component 304, then the detection of the hover input causes the settings application to display the dialog 305.

FIGS. 4a and 4b illustrate another example embodiment. FIG. 4a shows a mobile phone 400. In this example embodiment the user wishes to interact with the communication module of the mobile phone 400. The user wishes to interact with the communication module because the user wishes to check the network settings and see if adjustment is needed.

The mobile phone 400 has an antenna, which is a part of a communications unit, and is located in the upper part of the back-side of the mobile phone 400 outside of a graphical user interface area. The graphical user interface area comprises, in this example embodiment, an area of the mobile phone 400 that enables the user to interact with the mobile phone 400 using images instead of or in addition to text as means for interaction. In this example it further comprises physical or virtual keys that are intended to be used when for example entering text or numbers or which are used when scrolling a list or selecting an item displayed on the graphical user interface. In FIG. 4a it is illustrated how the user may tap with his finger 401 near the location at which the antenna is located. In this example embodiment a capacitive touch sensing capability of the mobile phone 400 enables the mobile phone to detect the tap. After detecting the touch input the mobile phone 400 enters a detection state for a pre-determined period of time during which, if the mobile phone 400 detects, in addition to the tap detected, another user input that is targeted at the notification bar 403, located in the graphical user interface area, illustrated in FIG. 4b, in this example embodiment the mobile phone 400 determines that these two user inputs relate to each other. In other words, the detection of an input at a location of a component may trigger the mobile phone 400 to enter a detection state in which it detects if the subsequent input detected is related to the input detected at the location of a component. If the period of time lapses and no user input targeted to the notification bar 403 is received, then the mobile phone 400 exits the detection state it entered after receiving the touch input at the location of the antenna. That is, even if there is a user input targeted at the notification bar 403 after the time has lapsed, the input is not determined to relate to the input received at the location of the antenna. Alternatively, no pre-determined period of time may exist and the mobile phone may remain in the detection state until a subsequent input is detected and it is determined whether the inputs detected relate to each other.

Once the user has tapped at the location of the antenna, in this example embodiment, there may be an indication that guides the user towards the notification bar 403. The guidance may be desirable as it helps the user to locate the area of the notification bar on the display quickly. The indication may comprise, for example, highlighting the notification bar 403 or highlighting an icon indicating the signal strength of the network in the notification bar 403. This may prompt a user to provide an input targeted towards the notification bar. The input targeted to the notification bar could be a touch input for example. In such case, the user may tap with his finger 401 on the notification bar 403. In this example embodiment, if such a tap is detected within a pre-defined time period, the tap detected at the location of the antenna and the tap detected at the notification bar are determined to relate to each other. In this example embodiment, since the user inputs are determined to relate to each other, the mobile phone 400 displays on the display 404 a dialog 405. The dialog 405 indicates current settings relating to the functionality of the communications module. For example, the mobile phone 400 may be set to use only a 3 G network. The dialog 405 also indicates the other options that can be selected. The dialog 405 in this example embodiment displays some, but not necessary all, options that relate to the functionality of the communication module. The options displayed by the dialog 405 are such that only one of those can be selected at a time. That is, the user is not enabled to choose more than one option at a time. To ensure that only one option is selected, radio buttons are used in the dialog 405. The user may interact with the dialog 405 by touching the radio button he wishes to select. Once a new radio button is selected, the previous selection is removed. Alternatively, the user may use the keypad 402 of the mobile phone 400 in order to interact with the dialog 405. The keypad 402 can be used to navigate between the selectable options and to verify a selection. The keypad may be for example a QWERTY keypad, ITU-T or the like.

A variation of the example embodiment illustrated in FIGS. 4a and 4b could be that the user first taps on the notification bar located at the top of the touch display. After receiving the tap, the mobile phone 400 may indicate to the user that if he now gives another user input by touching the location of the antenna on the back side of the mobile phone 400, the user is then enabled to interact with the communication unit that has an antenna included. The mobile phone may use the touch display, for example, for providing the indication. The display may, for example, have a pop-up notification which includes text indicating the possibility of being enabled to interact with the communications unit if the user now touches the phone at the location of the antenna. Alternatively, a picture or an animation could be used instead of text, or a combination of image and text could be used. Audio could also be utilized, in addition to or instead of text and/or an image or animation. For example, an audio could be played to alert the user that the notification bar has become selected, or that the user may now interact with the communications unit, if the user touches the mobile phone 400 at the location of the antenna. Further, the audio could be used along with indications shown on the touch display. If the user now provides another input by touching the mobile phone 400 at the location of the antenna, a dialog, like the dialog 405 illustrated in FIG. 4b, may be displayed to the user.

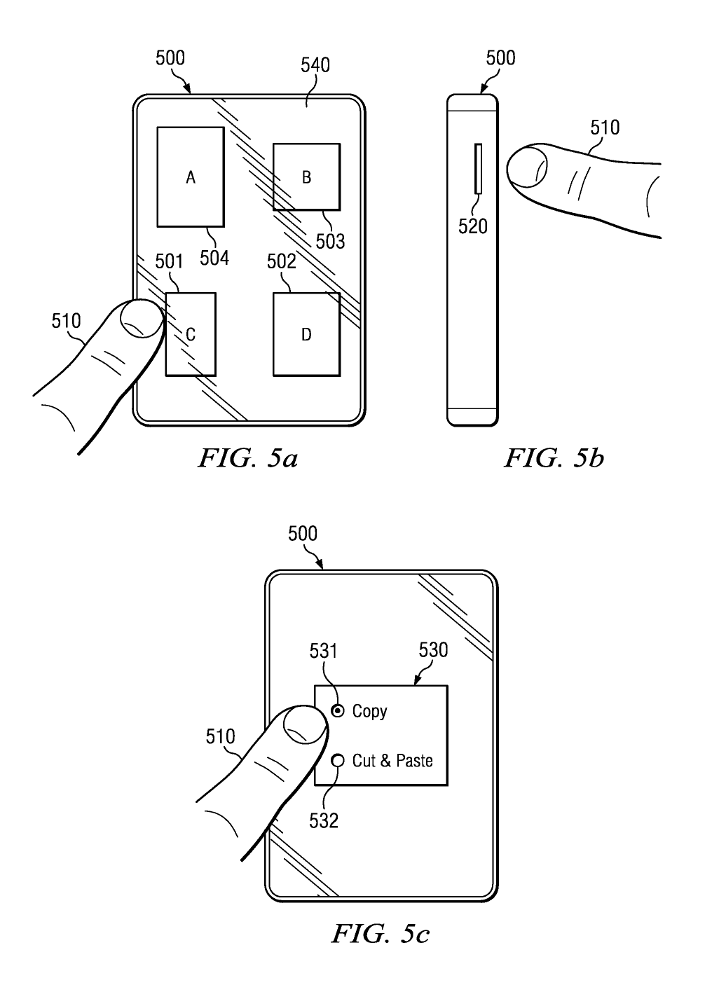

FIGS. 5a-5c illustrate another example embodiment. In this example embodiment, the user wants to interact with a memory card located in a memory card slot 520 of a tablet device 500. The memory card slot is located outside of a graphical user interface area of the tablet device 500. The purpose of this interaction is that the user wants to copy a file stored on a memory of the tablet device 500 to the memory card.

In the example embodiment depicted in FIG. 5a, the tablet device is in a detection state in which icons representing files 501, 502, 503 and 504 are displayed on a display 540 of the tablet device 500. The tablet device 500 is capable of detecting the proximity of a finger 510 of the user. That is, if the user has his finger 510 hovering within certain proximity of the tablet device 500, the tablet device 500 is aware of the user's finger 510. The display 540 of the tablet device 500 is a touch display and thus enables the user to interact with the tablet device 500 using touch-based user inputs. The user may now decide that he wants to copy file 501 to the memory card inserted into the memory card slot 520 of the tablet device 500. In order to copy the file 501 to the memory card, in this example embodiment, the user begins by selecting the file 501. The selection can be done by providing a user input, which in this case is double-tapping with the finger 510 on the icon representing the file 501 that is displayed on the display 540. The icon 501 may now indicate that it has become selected by for example having a different visual look compared to the situation in which it was not selected. In addition or alternatively, when the double-tap has been detected, the tablet device 500 may provide haptic feedback to the user indicating that the icon 502 has become selected. The haptic feedback could be, for example, a vibration that the user feels at his finger 510. In addition or instead, audio feedback may be provided by the tablet device 500 to indicate that the icon is now selected.

After double-tapping the icon 501, the user may, in this example embodiment, provide a subsequent user input, as is illustrated in FIG. 5b. To indicate that the user wants to copy the selected file represented by the icon 501, the user provides the subsequent input at the location of the memory card slot 520 in which the memory card is inserted. The location of the memory card slot 520 is on a side of the tablet device 500 in this example embodiment, but it would also be possible to have the memory card located elsewhere in the tablet device 500. The subsequent input in this case is a hover input. That is, the user places his finger 510 in close proximity to the memory card slot 520 and holds the finger still for a moment. The hover input may be detected at a distance of, for example, 5 cm or less from the memory card slot 520 and not touching the surface of the tablet device 500.

In order to be able to determine that the double-tap input and the hover input at the location of the memory card slot 520 of this example embodiment relate to each other, the tablet device, after detecting the double-tap, enters a detection state in which it detects for a pre-determined time period if a hover input is detected at the location of the memory card slot 520, within the pre-determined time period. If so, then it is determined that the double-tap and the hover detected relate to each other.

In this example embodiment, the memory card slot 520 may contain a memory card and the memory card is able to store a file. Once it has been determined that the double-tap and hover relate to each other, the file represented by the icon 501 may automatically be copied to the memory card. The tablet device 500 may also be configured such that after determining that the double-tap and hover relate to each other, there is a dialog 530 displayed on the display 540 as is illustrated in FIG. 5c. The dialog 530 in this example embodiment is configured to prompt the user to specify which action to take regarding the memory card and the file represented by the icon 501. The options in this example are that the file may be copied or cut and pasted to the memory card. If cut and pasted, the copy stored in the tablet device 500 would be deleted and the file would exist only in the memory card. In this example embodiment the user wants to copy the file to the memory card, so he selects the radio button 531 next to the copy option. The selection may be performed by touching the option “copy” with the finger 510. After the selection has been made, the file is copied to the memory card. It should be noted that there may be also other options in the dialog 530 than copy and cut and paste. Once the proper action regarding the data file has been taken, the tablet device may return to the detection state in which the icon representing the data file was chosen. Alternatively, a view with the contents of the memory card may be displayed on the display 540.

There may be variations to the example embodiment illustrated in FIGS. 5a-5c. For example, some of the icons 501-504 may represent folders containing data files instead of representing data files themselves. In addition or alternatively, the user may be enabled to select more than one data file or folder. The user inputs that select a data file or a folder may be user inputs received, for example, via a keyboard or voice recognition. Also, in some example embodiments, when receiving a user input at the location of the memory card slot 520, the function that may automatically be initiated may be something other than copying or displaying a dialog. The function to be automatically initiated may be, in some example embodiments, a default function that was set at the time of manufacturing the tablet device 500, or in some example embodiments it may be that the user is allowed, at any time, to select a function to be initiated in response to providing an input at the memory card slot 520.

In case the memory card slot 520 does not contain a memory card, the tablet device 500 may for example ignore the input received at the location of the memory card slot 520. In another example embodiment, the tablet device 500 may be configured to open a dialog informing the user that there is no memory card inserted in the memory card slot 520.

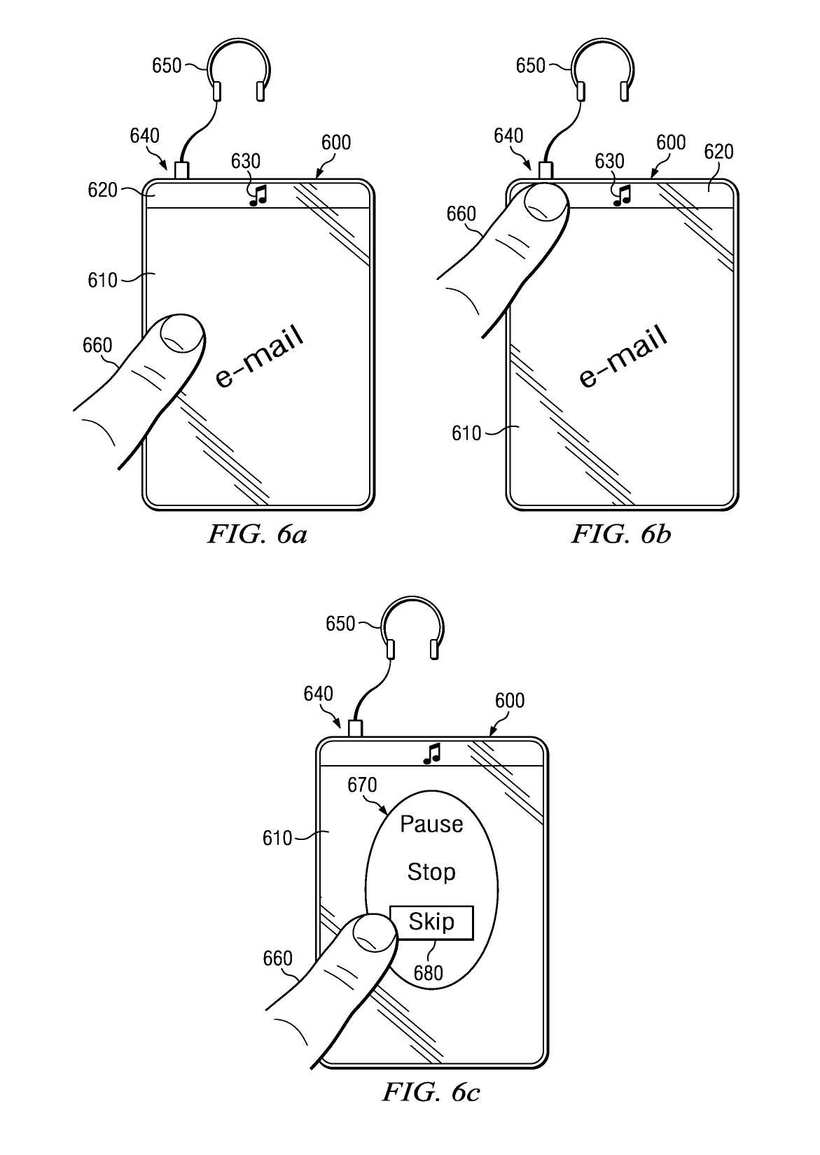

FIGS. 6a-6c address an example embodiment relating to a music player application. A user may at times have a headset 650 plugged into his mobile phone 600. This enables the user to listen to music files that are stored on the mobile phone 600. The mobile phone 600 in this example embodiment is able to play the music even if there is another application running on the mobile phone 600 at the same time. In this example embodiment, the user may wish to listen to music while reading his emails using an email application that is open and active on the display 610 of the mobile phone 600. When listening to music, the user may wish to, for example, skip a song. In this example embodiment, because the user has his e-mails open, it may be inconvenient for the user to have to navigate away from the e-mail application and select to open the view of the music player application from which he can then skip the song. It could be more convenient for example to have a dialog presented on top of the e-mail application that enables the user to skip the song. However, it would not be appropriate for such a dialog to be open constantly as it would be a distraction to the user and would unnecessarily occupy an area on the display 610 that could instead be utilized by the e-mail application. Instead, it would be preferable for the dialog to be easily available on demand.

In the example embodiment depicted in FIG. 6a, there is shown a mobile phone 600 that has many applications and in the illustration the user is actively interacting with the e-mail application displayed on the display 610. In this example embodiment a graphical user interface area comprises the display 610 which is a touch display. On the upper part of the touch display 610 there is a notification panel 620. The notification panel may be used to indicate to the user, for example, which applications are running on the mobile phone 600, what is the signal strength if the mobile phone 600 is connected to a wireless network or what is the condition of the battery of the mobile phone 600. In this example embodiment, the notification panel 620 is a section on the display 610 dedicated to conveying information to the user. The notification panel 620 may include icons that, when selected, open an application or a preview to an application. The notification panel 620 is in this example embodiment located at the top part of the display 610 but it should be noted that the notification panel 620 could be located elsewhere on the display 610. In another example embodiment the notification panel 620 may be a hidden panel, that is, visible only if the user, using a pre-determined user input, causes the notification panel 620 to become visible. In the example of FIG. 6a, there is an icon 630 visible in the notification panel 620 indicating that the music player application is running. The mobile phone 600 supports the usage of a headset 650. The headset 650 is a removable component of the mobile phone 600 located outside of the graphical user interface area. The headset 650, when connected, may be used as an output component through which the user hears the music played by the music player application. The headset 650 may be connected to the mobile phone 600 by plugging the headset 650 into the socket 640. The mobile phone 600 is capable of recognizing whether the headset 650 has been inserted into the socket 640. For example, in case the music player application of the mobile phone 600 is playing music and the headset 650 is removed from the socket 640, the music may be automatically paused. If the headset 650 is then inserted into the socket 640 again, the music can be heard from the headset 650 again.

While interacting with the e-mail application, in this example embodiment, the user may wish to quickly interact with the music player application as well without leaving the e-mail application. In this example embodiment, the user taps with his finger 660 the icon 630, causing the icon 630 to become selected. If the user then, within a certain period of time, subsequently hovers over the socket 640, as is illustrated in FIG. 6b, the tap and the hover are determined to be related to each other and, as a consequence, the mobile phone 600 displays options 670 relating to the music player application as can be seen in FIG. 6c. In this example embodiment the mobile phone 600 has capacitive sensing technology which enables the mobile phone 600 to recognize both touch and hover input. As the mobile phone 600 also recognized that there is a headset 650, a component related to the music player application, connected to the socket 640, the options relating to the music player application 670 are displayed. In this example embodiment, had the mobile phone 600 detected that the headset 650 is not connected to the socket 640, the mobile phone 600 would not display the options 670 relating to the music player application.

Once the options 670 relating to the music player application are displayed, the user may scroll though the list of options, select a desired option and return to the e-mail application. In this example embodiment, the user selects to skip the song that is currently being played. So the user taps on the option skip 680 with his finger 660. Now the mobile phone 600 plays the next song and the options 670 relating to the music player application are no longer displayed. Alternatively, the smart device 600 may continue to display the options 670 relating to the music player application until they are closed by the user.

Enabling the user to interact with the music player application as described above when the headset 650 has been connected to the mobile phone 600 may enable the user to have a larger display area dedicated to the e-mail application compared to a situation in which the options relating to the music player application 670 are constantly available. Further, this way the user can have the e-mail application visible in the background all the time which may be beneficial as it creates a feeling that the user does not have to leave the e-mail application in order to interact with the music player application. Embodiments of the invention can thus provide an improved ease of use compared with some other implementations.

Some example embodiments of the invention may be implemented on devices with wireless communication functionality. To be able to connect to a network when using a wireless communication device, a user may need to insert a subscriber identity module, which is from now on is referred to as a SIM card, into the device. In general, a SIM card is specific to a network operator providing wireless communication services. Network operators commonly have various options and prices for the services they offer. For example, operator A might offer cheap voice calls but have a higher price for all the data connection based services, whereas operator B might offer very cheap data connection based services but have a high price for phone calls made during office hours. Data connection based services refer to all network activity the device does that involves uploading or downloading data using packet data connections. Examples of these types of services are sending and receiving emails, downloading an application from the Internet, uploading a photo to social media sites etc. Because of the different pricing the operators may have for their services, a user may be inclined to use a data connection related services using a SIM card from operator B but to make phone calls that take place during office hours using a SIM card from operator A. In the following example, in order to be able to do this easily the user has a device that is able to use at least two different SIM cards simultaneously.

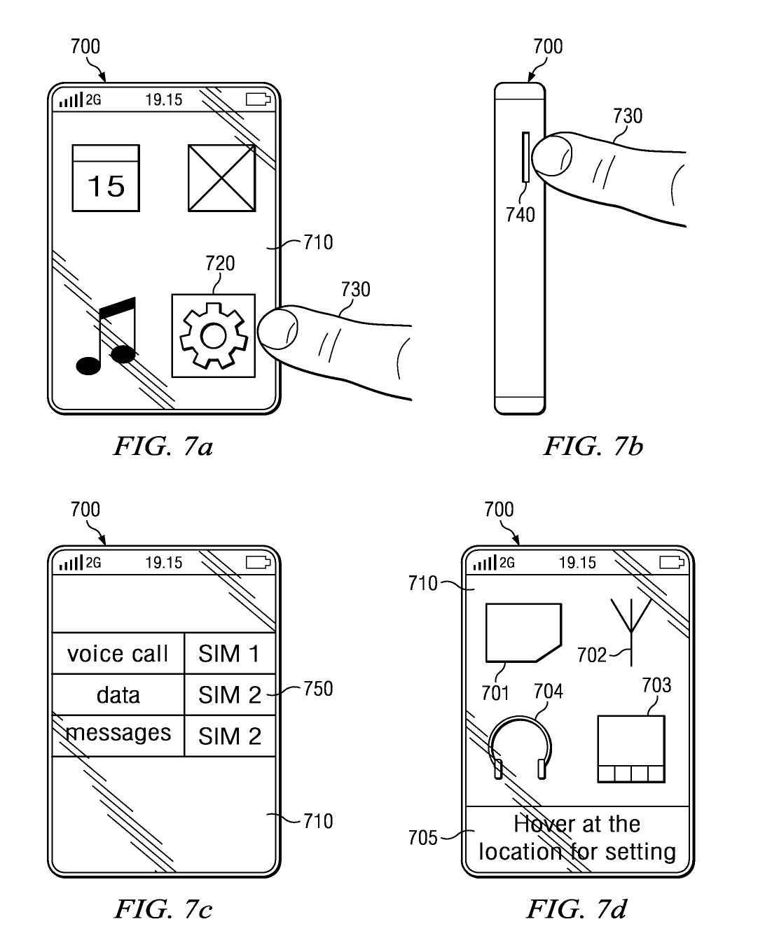

FIG. 7a is an illustration of an example embodiment in which there is a mobile device 700 that has a touch display 710. The touch display 710 uses capacitive sensing technology and may be able to detect not only touch user inputs on the screen but also hover user inputs above the display as well as around other parts of the mobile device 700. Alternatively or in addition, there may be one sensor dedicated to detection of touch user inputs on the screen and one or more other sensors dedicated to detection of hover inputs around all parts of the mobile device 700. On the touch display 710, in this example embodiment, there are various icons that represent applications, such as the icon 720 that represents a settings application. In this example the mobile device 700 is capable of using two SIM cards simultaneously, which means that the user may be connected to two different networks simultaneously. If the user wishes to define which SIM card is to be used for particular network related services, the user can access settings related to the functionalities that involve usage of the SIM cards. In this example, to access the settings the user taps the icon 720 using his finger 730. This causes the icon 720 to become selected, which is indicated to the user by highlighting the icon 720. After this the mobile device 700 detects if the next user input is related to the tap. The mobile device 700 in this example embodiment is aware of a number of user inputs that may be determined to relate to each other. The awareness is achieved by using programming methods to detect received user inputs and then determine if subsequent user inputs are related.

FIG. 7b illustrates a side view of the mobile device 700 of this example embodiment. On the side of the mobile device 700, outside of the graphical user interface area there is a SIM card slot 740 to which a SIM card may be inserted. There is, in this example embodiment, a further SIM card slot, though not illustrated in FIG. 7b, outside of the graphical user interface area in the mobile device 700 into which another SIM card may be inserted. The user may hover his finger 730 on top of the SIM card slot 740. Hovering at the location of the SIM slot 740 is a user input that is determined to be related to the tap. It should be noted that as the mobile device 700 is capable of having two SIM cards active at the same time, the hover user input could alternatively be received at the location of the other SIM card slot.

As the hover input was detected at the SIM card slot 740, the view 750 to the settings relating to the functionalities involving usage of the SIM cards is displayed on the display 710. The graphical user interface area in this example comprises the display 710. Had the hover been detected at the location of another component of the mobile device 700, then the view relating to the settings relating to the functionalities of that other component may be displayed on the touch display 710. By means of the view 750 to the settings relating to the SIM cards, the user is enabled to interact with the settings related to the functionalities involving usage of the SIM cards. That is, the user may view the current settings. If the user wishes to make changes, the user may provide user input, for example using the touch sensitive display 710. For example, if the user wishes to be asked which SIM card to use each time the user initiates a phone call, the user may change the setting of the voice call from SIM 1 to always ask. The SIM settings that the user may access may include for example, voice calls, messages, data connections. The options associated with each setting may include for example SIM 1, SIM 2 and always ask.

In another example embodiment, after the user has tapped the icon 720 and the icon 720 has become selected, the user may also be guided visually to hover at a location of the SIM card slot 740. This visual guidance is illustrated in FIG. 7d. For example, after the icon 720 has become selected, the touch sensitive display 710 may be configured to display visual guidance such as icons 701-704. The icon 701 represents a SIM card, the icon 702 represents an antenna, the icon 703 represents a memory card and the icon 704 represents a headset. In addition to the icons 701-704, textual guidance 705 is provided. The icons 701-704 are displayed in order to indicate to the user the components with which the user may be enabled to interact if the user hovers his finger 730 at the location of the respective component.

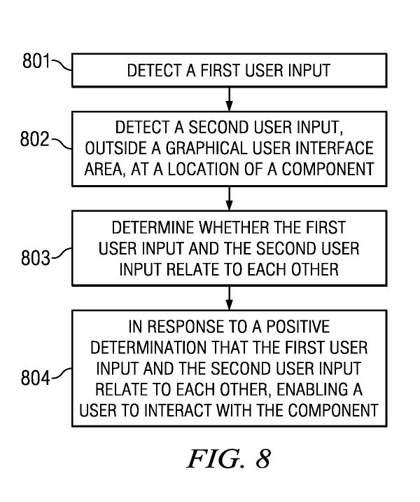

FIG. 8 shows a flow chart that describes an example embodiment. In block 801 a first user input is detected. A second user input, outside a graphical user interface area, at a location of a component is detected in block 802. Block 803 comprises determining whether the first user input and the second user input relate to each other and in block 804, in response to a positive determination that the first user input and the second user input relate to each other, a user is enabled to interact with the component.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
detecting a first user input;
detecting a second user input, outside a graphical user interface area, at a location of a component;
determining whether the first user input and the second user input relate to each other; and
in response to a positive determination that the first user input and the second user input relate to each other, enabling a user to interact with the component.

2. A method according to claim 1, wherein the first user input is detected at the graphical user interface area.

3. A method according to claim 1, wherein the component is a physical component integrated with an apparatus.

4. A method according to claim 1, wherein the component is an external component that can be removably attached to an apparatus.

5. A method according to claim 1, wherein determining whether the first user input and the second user input relate to each other comprises determining whether the first user input and the second user input are included in a set of pre-defined combinations of related user inputs.

6. A method according to claim 5, wherein the set of pre-defined combinations of related user inputs are defined in a database.

7. A method according to claim 5, wherein the set of pre-defined combinations of related user inputs are defined in a computer code algorithm.

8. A method according to claim 5, wherein determining whether the first user input and the second user input are included in a set of pre-defined combinations of related user inputs takes place only in a detection state.

9. A method according to claim 1, wherein the positive determination occurs only if a delay between the detection of the first user input and the detection of the second user input does not exceed a pre-determined time.

10. A method according to claim 1, wherein enabling the user to interact with the component comprises enabling the user to perform at least one of the following: access settings relating to functionality of the component, store data to the component, copy data from the component, view details relating to the component, or control an operation of the component.

11. A method according to claim 1, further comprising:
after detecting only one of the first user input or the second user input, notifying the user of at least one pre-defined combination of related user inputs that includes the detected first user input or second user input.

12. An apparatus, comprising at least one processor and at least one memory including computer program code, the at least one memory and the computer program code configured to, with the at least one processor, cause the apparatus at least to:
detect a first user input;
detect a second user input, outside a graphical user interface area, at a location of a component of the apparatus;
determine whether the first user input and the second user input relate to each other; and
in response to a positive determination that the first user input and the second user input relate to each other, enable a user to interact with the component.

13. A computer program product comprising a computer-readable medium bearing computer program code embodied therein for use with a computer, the computer program code comprising:
code for detecting a first user input;
code for detecting a second user input, outside a graphical user interface area, at a location of a component;
code for determining whether the first user input and the second user input relate to each other; and
code for, in response to a positive determination that the first user input and the second user input relate to each other, enabling a user to interact with the component.
